(19) United States
(12) Patent Application Publication
(10) Pub. No.: US 2005/0084004 A1
(43) Pub. Date: Apr. 21, 2005

(54) Wireless DOCSIS modem

(76) Inventor: Angelo Bione, Lawrenceville, GA (US)

Correspondence Address: ARRIS INTERNATIONAL, INC, 3871 LAKEFIELD DRIVE, SUWANEE, GA, 30024, US

(21) Appl. No.: 10/961,343

(22) Filed: Oct. 8, 2004

Related U.S. Application Data
(60) Provisional application No. 60/512,287, filed on Oct. 17, 2003.

(51) Int. Cl. H04B 1/38

(52) U.S. Cl. 375/222

(57) ABSTRACT

A user-device combines a DOCSIS modem and an upconverter radio circuit to convert upstream traffic signals from the modem output from the 5-42 MHz range to the Lower 700 MHz Band. This upconverted signal is amplified and transmitted from an antenna, which may be located external to the device, or inside the device. A local oscillator provides the upconverter radio circuit with a periodic signal having a frequency that is sufficiently different from the combined signal from the upconverter so that filtering the periodic signal from the combined signal does not require as precise tuning as if the carrier frequencies of the periodic signal and the combined signal were closer in frequency. A diplex filter, with the antenna electrically on one side and the upconverter radio circuit and a downstream amplifier on the other, separates upstream and downstream traffic from a single antenna connection.

### CROSS REFERENCE TO RELATED APPLICATION

This application priority under 35 U.S.C. 119(e) to Bione, U.S. provisional patent application No. 60/512,287 entitled “DOCSIS 700 MHz wireless modem”, which was filed Oct. 17, 2003, and is incorporated herein by reference in its entirety.

### FIELD OF THE INVENTION

The present invention relates generally to broadband communication networks, and more particularly to a method and system for wirelessly connecting a DOCSIS modem to a broadband network.

### BACKGROUND

Community antenna television (“CATV”) networks have been used for more then four decades to deliver television programming to a large number of subscribers. The CATV networks have typically been implemented using coaxial cables that form a network for electrically providing a signal path for video signals.

Aside from cable television network systems, use of the Internet continues to increase as a means of consumers receiving, and sending, information to providers and other Internet users. While use of the Internet typically requires a subscription with an Internet service provider (“ISP”), the Internet is available to practically anyone with a computer, because, in the United States, the federal government has for years required that telephony service be made available to everyone, no matter how remote. Thus, practically every resident has the ability to connect to, and become part of, the Internet. Moreover, many in such small markets have taken advantage of the access, and more and more sign up for Internet service with a provider every day in small as well as large markets.

While cable networks have been built out in most urban and suburban areas, and even in many rural areas, often in remote locations a CATV system operator typically has no incentive to invest in the construction of coaxial cable infrastructure. This lack of incentive exists because the few subscribers that might decide to subscribe if a provider built a coaxial network, would most likely not offset the investment cost, much less result in profitability for the provider.

Plain old telephone service (“POTS”) continues to be the medium that most Internet users use to connect to the Internet. A connection to the Internet using POTS is typically referred to as a dial-up connection. However, as use of the Internet continues to grow, and the amount and size of information that composes Internet traffic continues to grow, users are demanding better and better performance for their Internet experience than can be provided by a dial-up connection. Telephony companies have predictably responding to this demand by upgrading equipment at their central locations, typically referred to as central offices, to implement digital subscriber lines, or “DSL.” A DSL line, connected to Digital Subscriber Line Access Module at a central office can transmit and receive the digital information signals, referred to herein as “data,” at much faster rates than can be achieved using POTS and a dial-up connection.

However, telephony service providers are not required to upgrade their central office equipment to provide high-speed Internet, or data, service, also referred to as “broadband” service, to rural or remote locations, even though they are required to provide POTS service to such locations, and even though POTS and DSL service can be provided over the same twisted conductor pair.

In small markets where there is a CATV video system presence, subscribers may be able to have both broadband data and video services from the CATV service provider if the CATV system operator has upgraded some equipment at the central location to accommodate data delivery over the CATV coaxial network. Such upgraded equipment may typically comprise a Cable Modem Termination System (“CMTS”) for providing data services over the same coaxial cables used to deliver traditional cable television signals to subscribers. In such a system, subscribers typically use a cable modem at their premises. The data is transported over the coaxial cable network typically using the Data Over Cable Service Interface Specification (“DOCSIS”) protocol and video content is provided using the standard NTSC 6 MHz channel arrangement that is used by broadcast television stations. In the DOCSIS scheme, 6 MHz channels having center frequencies between 5 and 42 MHz are typically used for upstream transmission from the cable modem at the subscriber premises to the CMTS. It will be appreciated that the DOCSIS protocol in countries other than the United States may use a slightly different scheme, as channel spacing and frequency may be slightly different from country to country. Channels having center frequencies between 54 MHz up to about 750 MHz are typically used for delivering downstream video content, with certain channels being reserved for downstream data services from the CMTS to the subscriber's cable modem. Thus, the subscriber can access broadband data services and video content from the same coaxial drop from the coaxial network.

While a given rural area may be serviced by a nearby cable operator, some areas may be too remote to have cabling installed, thus connecting them to the cable network. Some attempts to provide a solution include connecting a modem device to an external (from the modem device) a radio transceiver, which may include, or otherwise be connected to an external antenna. However, this is cumbersome because each component must be connected together, usually with cable having connectors at each end. The discrete components each typically have a power supply which multiplies the power consumed by the number of components having a separate power supply, and each component covers a certain amount of area, for example on a desk top, which space is further consumed by the cabling connecting the components and the power supply wires.

Thus, there is a need for a method and system for providing broadband access to locations where a cable connection is not available, or is inconvenient. Furthermore, there is a need to provide wireless broadband access such that power consumption and space requirements are minimized.

### SUMMARY

A system provides broadband access where a cable connection is not available, or convenient, by including a DOCSIS cable modem and a radio transmitter in a single device. The transmitter facilitates wireless transmission of upstream data traffic signals from an antenna and a downstream signal amplifier boosts a downstream RF signal received from the antenna. A diplex filter between the RF antenna and the up and downstream amplifiers separate the upstream from the downstream RF traffic signals. The transmitter includes a local oscillator preferably set to output a signal at 674 MHz, which results in an output carrier frequency of 710 MHz when the DOCSIS modem section is providing an output at 36 MHz.

### BRIEF DESCRIPTION OF THE DRAWINGS

FIG. 1 illustrates a system for wirelessly accessing a broadband network.

FIG. 2 illustrates a block diagram of a wireless DOCSIS modem.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the, present invention or otherwise to exclude other embodiments, adaptations, variations, modifications and equivalent arrangements, the present invention being limited only by the claims appended hereto and the equivalents thereof.

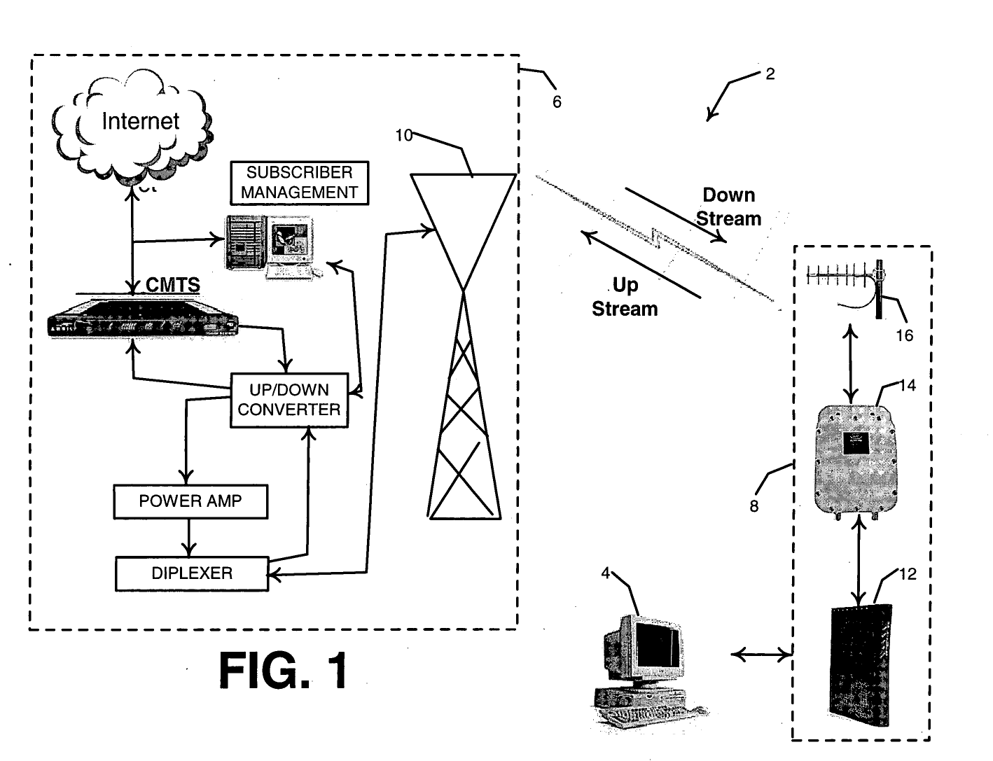

Turning now to the figures, FIG. 1 illustrates a system 2 for wirelessly transmitting and receiving communications signals between a users device 4, such as a computer, for example, and base station 6, such as a head end, for example. A wireless transmitter/receiver 8 interfaces with user-device 4 to receive and send signals between an antenna at the base station 6 and the user-device.

User-device 8 includes a modem 12, an upconverter 14, and an antenna 16. Thus, each of these components is included in the same device and can share the same power supply. An advantage is that having all components in close proximity and in the same housing typically results in lower noise intrusion as opposed to having discrete components, each with its own power supply and housing, and being connected externally—vis-à-vis each other, via cabling. Furthermore, since the circuitry can reside on a single board, less area, or ‘footprint’, is consumed by the external housing than would be if each component was enclosed in a separate housing.

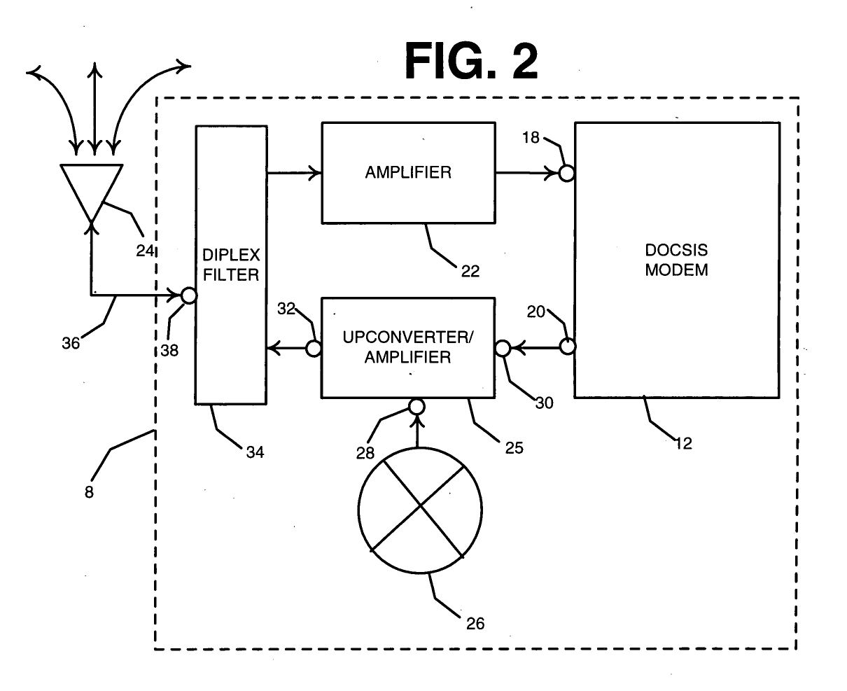

Turning now to FIG. 2, a block diagram of user-device 8 is shown. DOCSIS modem 12 may include circuitry known in the art for implementing broadband data communication according to DOCSIS. Such modem circuitry typically has an input 18 and an output 20 for receiving and sending data signals respectively. In 2002, the Federal Communications Commission (“FCC”) reallocated the 698-746 MHz spectrum band. (Lower 700 MHz Band, as defined by the FCC) that had been allocated to television Channels 52-59. Since a modem that operates according to the DOCSIS is calibrated to receive downstream signal in the 54 to approximately 800 MHz range, some of the upper channel frequencies of typical DOCSIS downstream signals fall in the Lower 700 MHz Band. Thus, conversion from one frequency range to another is not required for these frequencies to be broadcast in the Lower 700 MHz band from an antenna at a broadband service provider's head end. A downstream amplifier 22 in wireless modem 8 boosts downstream signals received by antenna 24 so that the signal strength is in the range expected by DOCSIS modem 12. In the upstream direction, however, a typical DOCSIS modem transmits data signals in the 6-52 MHz range using a time sharing scheme known in the art. Thus, to convert these upstream signals into the Lower 700 MHz Band, upconverter 25 is used. Upconverter 25 preferably includes an amplifier to increase the signal strength before the upstream signal is presented to antenna 24 for wireless transmission. Upconverter 25 is preferably a radio circuit known in the art, that receives a periodic signal from oscillator 26 at oscillator input 28. Upconverter 24 mixes the periodic signal received from the oscillator with the data signal received at signal input 30, so that the signal output from the upconverter has a carrier frequency in the Lower 700 MHz band. The preferred carrier frequency is 710 MHz, with a periodic signal frequency from oscillator 26 of 674 MHz and the data signal from the DOCSIS modem having carrier frequency of 36 MHz. These frequency preferences provide adequate separation between the final carrier frequency of 710 and the periodic signal of 674.

Separation of more than a few MHz is desirable so that when the modulated output signal is filtered before being output at output 32 of upconverter 25, the center frequency tolerance of the filter that is designed to remove the 674 MHz component does not have to be as close as if the output frequency was closer to the oscillator frequency. This is because the closer the oscillator frequency is to the final composite signal output from upconverter 25, the more precise the tolerances of the filter that reduces the oscillator signal component from the composite 710 MHz signal that is output from output 32. Such filtering of the periodic signal from the mixed composite signal from a radio circuit is known in the art. It will be appreciated that, although using a oscillator frequency of 674 is preferred, other oscillator/modem frequency combinations may be used to change frequencies in a system or reduce interference with other signals.

Diplex filter 34 facilitates the use of a single antenna 24 for upstream and downstream signal traffic. In the preferred embodiment, an antenna 24 external to the device 8 and related components may be used. In such embodiment, diplex filter 34 further facilitates a single connection line 36 coupling antenna 24 and the connection port 38 of diplex filter 34. In an alternative embodiment, antenna 24 is formed on the same circuit board as diplex filter 34, amplifier 22, upconverter 25, oscillator 26 and modem 12. In another embodiment, antenna 24 is enclosed with, but separate from, the circuit board containing modem 12, amplifier 22, upconverter 24 and diplex filter 34.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A user-device for wirelessly communicating with a network, comprising:
a means for modulating and demodulating communication signals, said means having an input and an output;
a means for upconverting an upstream communication signal received from the output of the modulating/demodulating means, said upconverting means having a signal input, a oscillator input and an output, the signal input being coupled to the output of the modulating/demodulating means; and
an oscillator means for producing a periodic signal at a predetermined frequency at an output, said output being coupled to the oscillator input of the upconverter means.

2. The device of claim 1 further comprising an antenna for wirelessly receiving downstream signals and for emitting a signal received from the output of the upconverter means.

3. The device of claim 1 further comprising a means for boosting the downstream signal before being provided to the input of the modulation/demodulation means.

4. The device of claim 1 wherein the means for modulating and demodulating communication signals is a DOCSIS modem.

5. The device of claim 1 wherein the oscillator means is a local oscillator fixed at a frequency of 674 Mhz.

6. The device of claim 1 wherein the upconverter means includes a mixer means for combining the periodic signal from the oscillator and the upstream communication signal into an upconverted signal, said upconverted signal having a carrier frequency that is the sum of the periodic signal and the upstream communication signal.

7. The device of claim 6 wherein the upconverter means includes a means for boosting the signal strength of the upconverted signal.

8. The device of claim 7 further comprising an antenna for wirelessly receiving downstream signals and for emitting a signal received from the output of the upconverter means, wherein the upconverted signal is provided to the antenna for wireless transmission to a remote location.

9. A user-device for wirelessly communicating with a network, comprising:
a DOCSIS modem for modulating and demodulating communication signals, said DOCSIS modem having an input and an output;
a means for upconverting an upstream communication signal received from the output of the modulating/demodulating means, said upconverting means having a signal input, a oscillator input and an output, the signal input being coupled to the output of the modulating/demodulating means; and
an oscillator means for producing a periodic signal at a predetermined frequency at an output, said output being coupled to the oscillator input of the upconverter means.

10. The device of claim 9 further comprising an antenna for wirelessly receiving downstream signals and for emitting a signal received from the output of the upconverter means.

11. The device of claim 9 further comprising a means for boosting the downstream signal before being provided to the input of the modulation/demodulation means.

12. The device of claim 9 wherein the oscillator means is a local oscillator fixed at a frequency of 674 MHz.

13. The device of claim 9 wherein the upconverter means includes a mixer means for combining the periodic signal from the oscillator and the upstream communication signal into an upconverted signal, said upconverted signal having a carrier frequency that is the sum of the periodic signal and the upstream communication signal.

14. The device of claim 13 wherein the upconverter means includes a means for boosting the signal strength of the upconverted signal.

15. The device of claim 14 further comprising an antenna for wirelessly receiving downstream signals and for emitting a signal received from the output of the upconverter means, wherein the upconverted signal is provided to the antenna for wireless transmission to a remote location.

16. A method for wirelessly communicating with a network with a user-device, comprising:
receiving an upstream communication signal having a first carrier frequency from a DOCSIS modem that is part of the device;
upconverting the upstream communication signal first carrier frequency to a second carrier frequency using an upconverter that is a component of the device;
and emitting the upconverted communication signal from an antenna that is a component of the device.

17. The method claim 16 wherein the device further comprises an antenna for wirelessly receiving downstream signals and for emitting a signal received from the output of the upconverter means.

18. The method claim 16 wherein the device further comprises a means for boosting the downstream signal before being provided to the input of the modulation/demodulation means.

19. The method claim 16 wherein the device further comprises an oscillator means is a local oscillator fixed at a frequency of 674 Mhz.

20. The method of claim 16 wherein the device further comprises a mixer means for combining the periodic signal from the oscillator and the upstream communication signal into an upconverted signal, said upconverted signal having a carrier frequency that is the sum of the periodic signal and the upstream communication signal.

21. The method of claim 16 further comprising boosting the signal strength of the upconverted signal.

22. The method of method 16 wherein the device further comprises an antenna for wirelessly receiving downstream signals and for emitting a signal received from the output of the upconverter means, wherein the upconverted signal is provided to the antenna for wireless transmission to a remote location.
